(19) United States
(12) Patent Application Publication
(10) Pub. No.: US 2007/0259158 A1
(43) Pub. Date: Nov. 8, 2007

(54) User interface and method for displaying information in an ultrasound system

(75) Inventors: Zvi Friedman, Kiryat Bialik (IL); Sergei Goldenberg, Kiryat-Ata (IL); Peter Lysyansky, Harofe (IL); Gunnar Hansen, Horten (NO)

Correspondence Address: DEAN D. SMALL;THE SMALL PATENT LAW GROUP LLP, 611 OLIVE STREET, SUITE 1611, ST. LOUIS, MO, 63101, US

(73) Assignee: General Electric Company

(21) Appl. No.: 11/418,778

(22) Filed: May 5, 2006

(51) Int. Cl. B44C 1/17

(52) U.S. Cl. 428/195.1

(57) ABSTRACT

A user interface and method for displaying information in connection with an ultrasound system are provided. In accordance with an embodiment of the present invention, a method for automatically displaying information during medical image processing is provided. The method includes determining an image view for a displayed image generated from acquired scan data and determining text to display in connection with a marker displayed on the displayed image based on the determined image view. The text indicates a region of the displayed image to identify with the marker. The method further includes displaying automatically the determined text in connection with the marker on the displayed image.

### BACKGROUND OF THE INVENTION

Embodiments of the present invention relate generally to medical imaging systems, and more particularly, to medical imaging systems having functionality to aid a user in processing medical image data.

Ultrasound systems are used in a variety of applications and by individuals with varied levels of skill. In many examinations, operators of the ultrasound system must provide inputs in order for the system to properly process the information for later analysis. For example, a user may have to select certain regions or points on an image to process the data for that acquired image. The user often must keep track of the various inputs to ensure that the selections are made correctly, such as in the proper order and/or that all inputs required for a particular processing operation are entered. If the user inputs are not entered correctly or completely, subsequent processing of the data may be incorrect, which can result in errors in analysis and/or improper diagnosis.

Additionally, the information provided to an operator of the system also may make it difficult to provide the necessary inputs. For example, it may be difficult for an operator to distinguish between different regions on a displayed image. This can result in error in the user inputs, for example, in selecting reference or identification points on the image that are used by the system for processing the acquired image data.

Thus, operators using known interfaces often must separately keep track of selections to ensure proper processing. This may include writing the information down on a separate notepad of trying to remember what information has been provided. This can lead to errors if the user incorrectly remembers the information already entered and/or the order of the entered information. Additionally, these user interfaces may be difficult to navigate and do not provide indications of different user inputs. Accordingly, these known systems may result in increased processing time and reduced workflow or examination throughput.

### BRIEF DESCRIPTION OF THE INVENTION

In accordance with an embodiment of the present invention, a method for automatically displaying information during medical image processing is provided. The method includes determining an image view for a displayed image generated from acquired scan data and determining text to display in connection with a marker displayed on the displayed image based on the determined image view. The text indicates a region of the displayed image to identify with the marker. The method further includes displaying automatically the determined text in connection with the marker on the displayed image.

In accordance with another embodiment of the present invention, a method for automatically displaying status information during medical image processing is provided. The method includes determining a status of a current processing operation, determining a status of an overall processing operation and providing an indication of the status of the current processing operation and the overall processing operation on a displayed segment status indicator.

In accordance with yet another embodiment of the present invention, a medical image display is provided that includes an image portion displaying an image from an acquired medical imaging scan and a non-image portion displaying information relating to the displayed image. The non-image portion includes a status indicator having a plurality of segments indicating a status of an operation performed in connection with the displayed image.

In accordance with still another embodiment of the present invention, a medical image display is provided that includes an image portion displaying an image from an acquired medical imaging scan and a non-image portion displaying information relating to the displayed image. The medical image display further includes a virtual marker and associated text displayed on the image portion. The associated text is automatically displayed based on a determined image view of an image displayed in the image portion. The text indicates a region of the displayed image to identify with the marker.

### BRIEF DESCRIPTION OF THE DRAWINGS

FIG. 1 is a block diagram of a diagnostic ultrasound system formed in accordance with an embodiment of the present invention.

FIG. 2 is a block diagram of an ultrasound processor module of the diagnostic ultrasound system of FIG. 1 formed in accordance with an embodiment of the invention.

FIG. 3 illustrates a window presented on a display for use in processing image information in accordance with an embodiment of the invention.

FIG. 4 is a flowchart of a method for determining text to display on the window of FIG. 3 in accordance with an embodiment of the invention.

FIG. 5 illustrates an image including a marker and associated text presented on a display in accordance with an embodiment of the invention.

FIG. 6 illustrates another image including a marker and associated text presented on a display in accordance with an embodiment of the invention.

FIG. 7 illustrates the window of FIG. 3 presented on a display and having a control panel provided in accordance with an embodiment of the invention.

FIG. 8 illustrates the control panel of FIG. 7 presented on the display in accordance with an embodiment of the invention.

FIG. 9 illustrates a status indicator in one state in accordance with an embodiment of the invention.

FIG. 10 illustrates the status indicator in another state in accordance with an embodiment of the invention.

FIG. 11 illustrates the status indicator in another state in accordance with an embodiment of the invention.

FIG. 12 illustrates the status indicator in another state in accordance with an embodiment of the invention.

FIG. 13 illustrates the status indicator in another state in accordance with an embodiment of the invention.

FIG. 14 illustrates the status indicator in another state in accordance with an embodiment of the invention.

### DETAILED DESCRIPTION OF THE INVENTION

Exemplary embodiments of ultrasound systems and methods for facilitating user inputs are described in detail below. In particular, a detailed description of an exemplary ultrasound system will first be provided followed by a detailed description of various embodiments of methods and systems for providing information on a display to facilitate user inputs to process acquired image data. A technical effect of the various embodiments of the systems and methods described herein include at least one of facilitating the process for correctly entering and selecting information using a user interface of an ultrasound system.

It should be noted that although the various embodiments may be described in connection with an ultrasound system, the methods and systems described herein are not limited to ultrasound imaging. In particular, the various embodiments may be implemented in connection with different types of medical imaging, including, for example, magnetic resonance imaging (MRI) and computed-tomography (CT) imaging. Further, the various embodiments may be implemented in other non-medical imaging systems, for example, non-destructive testing systems.

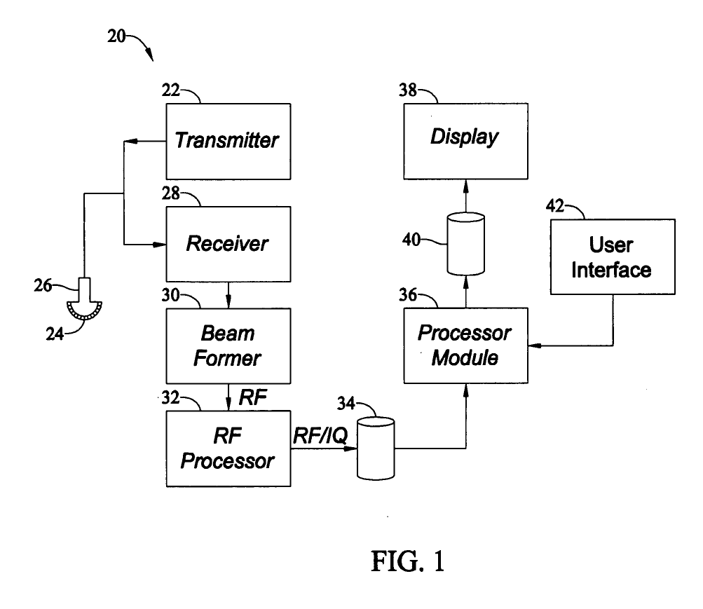

FIG. 1 illustrates a block diagram of an ultrasound system 20, and more particularly, a diagnostic ultrasound system 20 formed in accordance with an embodiment of the present invention. The ultrasound system 20 includes a transmitter 22 that drives an array of elements 24 (e.g., piezoelectric crystals) within a transducer 26 to emit pulsed ultrasonic signals into a body or volume. A variety of geometries may be used and the transducer 26 may be provided as part of, for example, different types of ultrasound probes. The ultrasonic signals are back-scattered from structures in the body, for example, blood cells or muscular tissue, to produce echoes that return to the elements 24. The echoes are received by a receiver 28. The received echoes are provided to a beamformer 30 that performs beamforming and outputs an RF signal. The RF signal is then provided to an RF processor 32 that processes the RF signal. Alternatively, the RF processor 32 may include a complex demodulator (not shown) that demodulates the RF signal to form IQ data pairs representative of the echo signals. The RF or IQ signal data may then be provided directly to a memory 34 for storage (e.g., temporary storage).

The ultrasound system 20 also includes a processor module 36 to process the acquired ultrasound information (e.g., RF signal data or IQ data pairs) and prepare frames of ultrasound information for display on a display 38. The processor module 36 is adapted to perform one or more processing operations according to a plurality of selectable ultrasound modalities on the acquired ultrasound information. Acquired ultrasound information may be processed in real-time during a scanning session as the echo signals are received. Additionally or alternatively, the ultrasound information may be stored temporarily in the memory 34 during a scanning session and processed in less than real-time in a live or off-line operation. An image memory 40 is included for storing processed frames of acquired ultrasound information that are not scheduled to be displayed immediately. The image memory 40 may comprise any known data storage medium, for example, a permanent storage medium, removable storage medium, etc.

The processor module 36 is connected to a user interface 42 that controls operation of the processor module 36 as explained below in more detail and is configured to receive inputs from an operator. The display 38 includes one or more monitors that present patient information, including diagnostic ultrasound images to the user for review, diagnosis and analysis. The display 38 may automatically display, for example, multiple planes from a three-dimensional (3D) ultrasound data set stored in the memory 34 or 40. One or both of the memory 34 and the memory 40 may store 3D data sets of the ultrasound data, where such 3D data sets are accessed to present 2D and 3D images. For example, a 3D ultrasound data set may be mapped into the corresponding memory 34 or 40, as well as one or more reference planes. The processing of the data, including the data sets, is based in part on user inputs, for example, user selections received at the user interface 42.

In operation, the system 20 acquires data, for example, volumetric data sets by various techniques (e.g., 3D scanning, real-time 3D imaging, volume scanning, 2D scanning with transducers having positioning sensors, freehand scanning using a voxel correlation technique, scanning using 2D or matrix array transducers, etc.). The data is acquired by moving the transducer 26, such as along a linear or arcuate path, while scanning a region of interest (ROI). At each linear or arcuate position, the transducer 26 obtains scan planes that are stored in the memory 34.

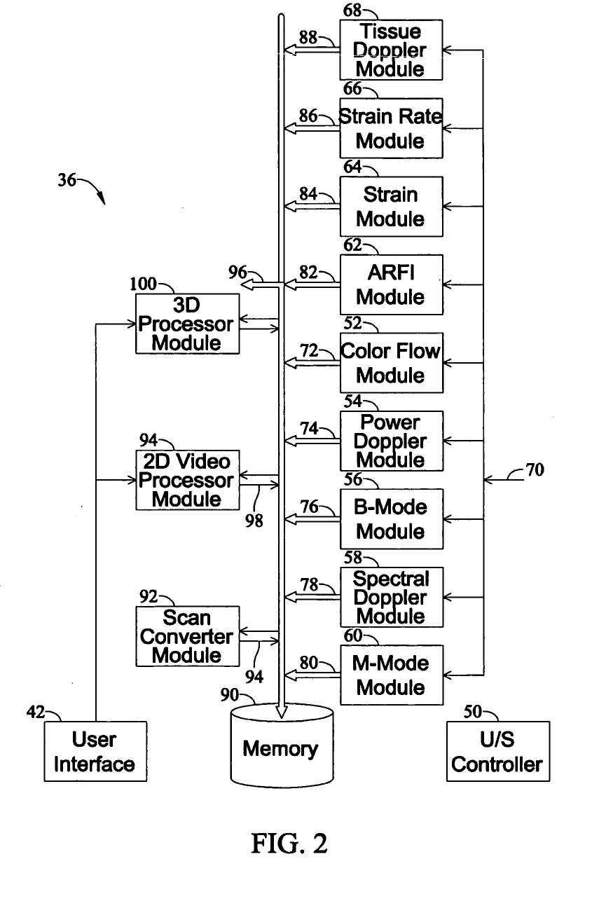

FIG. 2 illustrates an exemplary block diagram of the ultrasound processor module 36 of FIG. 1 formed in accordance with an embodiment of the present invention. The ultrasound processor module 36 is illustrated conceptually as a collection of sub-modules, but may be implemented utilizing any combination of dedicated hardware boards, DSPs, processors, etc. Alternatively, the sub-modules of FIG. 2 may be implemented utilizing an off-the-shelf PC with a single processor or multiple processors, with the functional operations distributed between the processors. As a further option, the sub-modules of FIG. 2 may be implemented utilizing a hybrid configuration in which certain modular functions are performed utilizing dedicated hardware, while the remaining modular functions are performed utilizing an off-the shelf PC and the like. The sub-modules also may be implemented as software modules within a processing unit.

The operations of the sub-modules illustrated in FIG. 2 may be controlled by a local ultrasound controller 50 or by the processor module 36. The sub-modules 52-68 perform mid-processor operations. The ultrasound processor module 36 may receive ultrasound data 70 in one of several forms. In the embodiment of FIG. 2, the received ultrasound data 70 constitutes I,Q data pairs representing the real and imaginary components associated with each data sample. The I,Q data pairs are provided to one or more of a color-flow sub-module 52, a power Doppler sub-module 54, a B-mode sub-module 56, a spectral Doppler sub-module 58 and an M-mode sub-module 60. Optionally, other sub-modules may be included such as an Acoustic Radiation Force Impulse (ARFI) sub-module 62, a strain module 64, a strain rate sub-module 66, a Tissue Doppler (TDE) sub-module 68, among others. The strain sub-module 62, strain rate sub-module 66 and TDE sub-module 68 together may define an echocardiographic processing portion.

Each of sub-modules 52-68 are configured to process the I,Q data pairs in a corresponding manner to generate color-flow data 72, power Doppler data 74, B-mode data 76, spectral Doppler data 78, M-mode data 80, ARFI data 82, echocardiographic strain data 82, echocardiographic strain rate data 86 and tissue Doppler data 88, all of which may be stored in a memory 90 (or memory 34 or image memory 40 shown in FIG. 1) temporarily before subsequent processing. The data 72-88 may be stored, for example, as sets of vector data values, where each set defines an individual ultrasound image frame. The vector data values are generally organized based on the polar coordinate system.

A scan converter sub-module 92 access and obtains from the memory 90 the vector data values associated with an image frame and converts the set of vector data values to Cartesian coordinates to generate an ultrasound image frame 94 formatted for display. The ultrasound image frames 94 generated by the scan converter module 92 may be provided back to the memory 90 for subsequent processing or may be provided to the memory 34 or the image memory 40.

Once the scan converter sub-module 92 generates the ultrasound image frames 94 associated with, for example, the strain data, strain rate data, and the like, the image frames may be restored in the memory 90 or communicated over a bus 96 to a database (not shown), the memory 34, the image memory 40 and/or to other processors (not shown).

As an example, it may be desired to view different types of ultrasound images relating to echocardiographic functions in real-time on the display 38 (shown in FIG. 1). To do so, the scan converter sub-module 92 obtains strain or strain rate vector data sets for images stored in the memory 90. The vector data is interpolated where necessary and converted into an X,Y format for video display to produce ultrasound image frames. The scan converted ultrasound image frames are provided to a display controller (not shown) that may include a video processor that maps the video to a grey-scale mapping for video display. The grey-scale map may represent a transfer function of the raw image data to displayed grey levels. Once the video data is mapped to the grey-scale values, the display controller controls the display 38, which may include one or more monitors or windows of the display, to display the image frame. The echocardiographic image displayed in the display 38 is produced from an image frame of data in which each datum indicates the intensity or brightness of a respective pixel in the display. In this example, the display image represents muscle motion in a region of interest being imaged.

Referring again to FIG. 2, a 2D video processor sub-module 94 combines one or more of the frames generated from the different types of ultrasound information. For example, the 2D video processor sub-module 94 may combine a different image frames by mapping one type of data to a grey map and mapping the other type of data to a color map for video display. In the final displayed image, the color pixel data is superimposed on the grey scale pixel data to form a single multi-mode image frame 98 that is again re-stored in the memory 90 or communicated over the bus 96. Successive frames of images may be stored as a cine loop in the memory 90 or memory 40 (shown in FIG. 1). The cine loop represents a first in, first out circular image buffer to capture image data that is displayed in real-time to the user. The user may freeze the cine loop by entering a freeze command at the user interface 42. The user interface 42 may include, for example, a keyboard and mouse and all other input controls associated with inputting information into the ultrasound system 20 (shown in FIG. 1).

A 3D processor sub-module 100 is also controlled by the user interface 42 and accesses the memory 90 to obtain spatially consecutive groups of ultrasound image frames and to generate three dimensional image representations thereof, such as through volume rendering or surface rendering algorithms as are known. The three dimensional images may be generated utilizing various imaging techniques, such as ray-casting, maximum intensity pixel projection and the like.

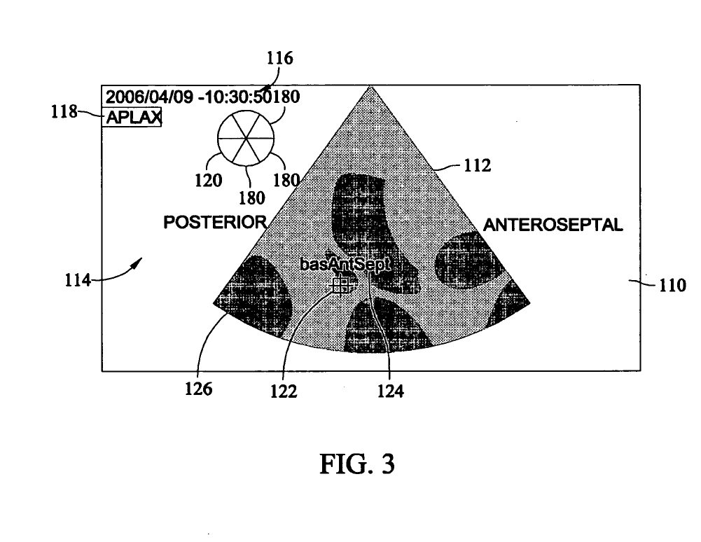

Various embodiments of the present invention provide indications on a screen display for use by a user when, for example, entering information using the user interface 42 (shown in FIG. 1) or selecting regions or points of interest using the user interface 42. FIG. 3 is an exemplary window 110 (or display panel) that may be presented on the display 38 (shown in FIG. 1) or a portion thereof and controlled by the user interface 42. The user may access different input means as part of the user interface 42, for example, a mouse, trackball, keyboard, among others. The window 110 generally includes an image portion 112 and a non-image portion 114 that may provide different information relating to the image being displayed, the status of the system, etc. For example, the non-image portion 112 may include time and date information 116, an image type label 118 and a status indicator 120. More particularly, the time and date information 116 may show the current time and date or the time and date at which the image being displayed on the image portion 112 was acquired. The image type label 118 provides an indication of, for example, the view of the image being displayed, which in the exemplary window 110 is an Apical Long Axis (APLAX) view. The status indicator 120 provides an indication of the status of the current system processing and the overall system processing as described in more detail below.

Various embodiments also include a virtual marker 122 with associated text 124 that is also displayed on the image portion 112. More particularly, based on the type of image being displayed as indicated by the image type label 118, a virtual marker 122, configured in this embodiment as a circle with crosshairs, is provided in connection with the associated text 124 that may describe a region to be identified on the image 126. The associated text 124 may be displayed based on a type of processing to be performed. For example, in processing operations, different points of the displayed image 126 may need to be marked in order to determine information relating to the image 126, such as to generate a border of a structure shown in the image 126 (e.g., endocardial border). More particularly, the associated text 124 indicates the region of the image 126 to be identified, for example, a point on the image 126 to be selected by a user, such as, by moving the marker 122 to that point and selecting that point using the input means of the user input 42.

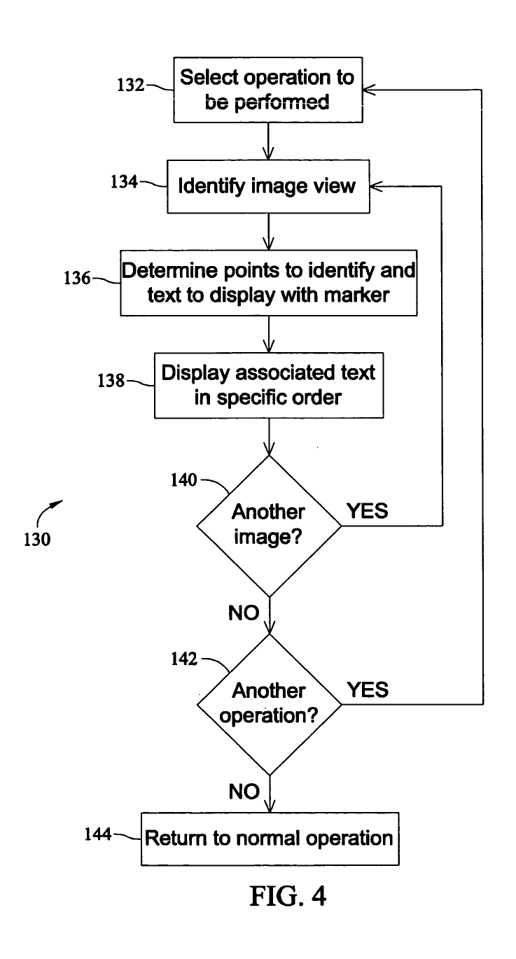

As an example, when determining the endocardial border using any known process, specific points on images 126 in different views must be identified in a particular order. Specifically, in one embodiment, in order to generate the endocardial border, three points on each of three views must be identified and selected. These points must be selected in a particular order. According to various embodiments of the invention, the associated text 124 automatically changes based on the point to be identified and selected. An exemplary method 130 for determining the associated text 124 to display is shown in FIG. 4. The method 130 includes a user initially selecting at 132 an operation to be performed by the ultrasound system 20, which processing may be performed by the processor module 36 using one of the sub-modules shown in FIG. 2. Accordingly, a user may enter on a selection screen (not shown) or on the window 110, for example, in a pull-down menu or selection field (not shown), that the operation to be performed is a determination of the endocardial border of the image displayed. Once, the operation to be performed has been selected, and an image 126 is displayed, the image view of the image 126 being displayed is identified at 124. For example, a user may enter on a keyboard of the user interface 42 the image view. This view type is then displayed by the image type label 118. It should be noted that the image 126 to be displayed may be accessed form a local storage device, for example, the image memory 40 (shown in FIG. 1). In an alternate embodiment, the view is automatically identified based on the image accessed from the local storage device.

Once the image view is entered, the points to be identified and corresponding to text to display are determined at 136. Specifically, and continuing with the example of determining the endocardial border, a table is accessed that identifies the specific points to be identified and selected on the image 126, the order of the identification and the associated text 124 to display with the marker 122. An exemplary table identified as Table 1 below illustrates the order of selection and associated text 124 to display based on the image view.

TABLE 1

| | Apical Long | | |
|---|---|---|---|
| Image View | Axis (APLAX) | Two-Chamber | Four-Chamber |
| Associated Text 1 | Posterior | Inferior | Basal Septum |
| Associated Text 2 | Anteroseptal | Basal Anterior | Basal Lateral |
| Associated Text 3 | Apex | Apex | Apex |

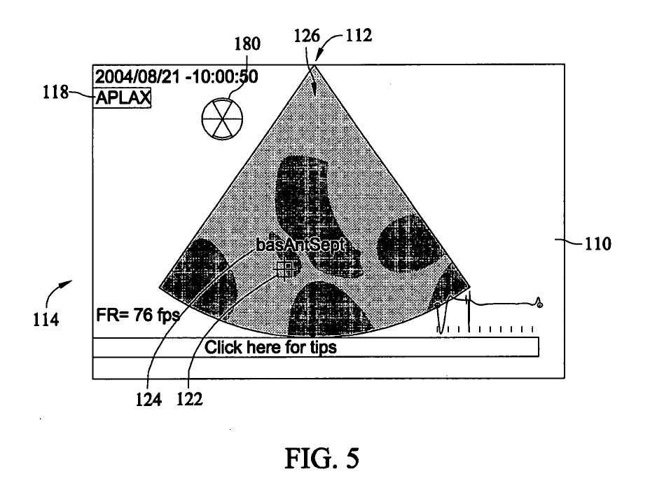

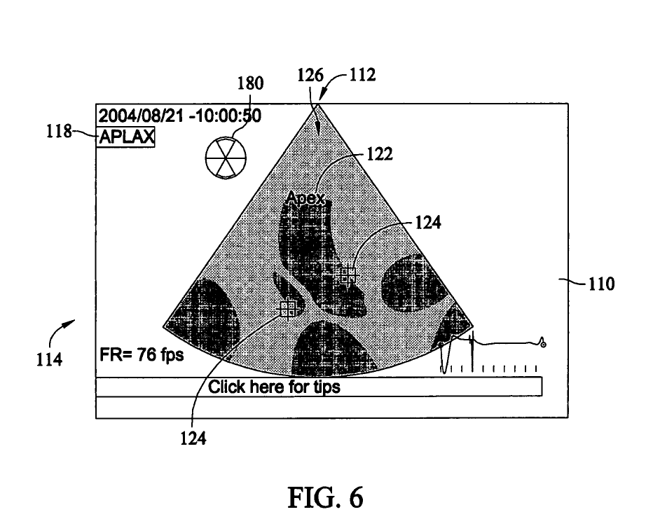

Table 1 defines for each image view selected at 134 the associated text 124 to be displayed with the marker 122 and the order of the text 124, namely, Associated Text 1, followed by Associated Text 2 and finally Associated Text 3. It should be noted that the text displayed may be an abbreviation of the text shown in Table 1 or a variation thereof. Accordingly, at 138, the associated text 124 is displayed. In operation, and for example, in an APLAX view, “Posterior” (i.e., Associated Text 1) is first displayed as the associated text 124 is displayed in connection with the marker 122. Once the corresponding point on the image 126 has been identified (e.g., selected by a user with the marker 122), Associated Text 2 is displayed, which as shown in FIG. 5, may be abbreviated text, namely “AntSept.” Once the corresponding point on the image is identified, the final text, Associated Text 3 is displayed, and in particular, the associated text 124 “Apex” is displayed in connection with the marker 122 as shown in FIG. 6. It should be noted that once a point is marked on the image 126, the marker 122 and/or associated text 124 may disappear or may continue to be displayed at the identified point.

Once all three points have been identified, the method 130 may be repeated for other image views, for example, a two chamber and a four chamber view. Specifically, at 140 a determination is made as to whether another image 126 is to be processed. If another image 126 is to be processed, then the image is identified at 134. If there are no additional images to process as determined at 140, then at 142 a determination is made as to whether another operation 142 is to be performed. If another operation is to be performed, then the operation is selected at 132. If no further operation is to be performed as determined at 142, then at 144 the system returns to normal operation.

Thus, using the marker 122 and associated text 124 various embodiments provide guidance for entering information related to a specific processing operation. For example, by marking specific points in different image views (e.g., two points at the base of the heart and one point at the apex), the processor module 36 (shown in FIG. 1) may automatically determine the endocardial border between heart muscle and the heart cavity using any known process.

It should be noted that the window 110 may be configured such that if an image 126 displayed is inverted, for example, in the left/right orientation, the various embodiments relabel the image walls and segments accordingly. In particular, Table 1 above also may further include information relating to an expected location of one point relative to another point, for example, one point in one of the views is expected to be to the left of another point. If it is determined that the point is instead selected to the right of the other point, which may be determined by a map of the pixel elements provided in any known manner, the labels for each of the walls of the heart and the segments therein are automatically renamed. For example, if the posterior wall is labeled to the left of the image 126 and the anteroseptal wall is labeled to the right of the image 126 as shown in FIG. 3, if the image is inverted, which may be determined by the points selected by a user, the labels switch with the posterior label on the right of the image 126 and the anteroseptal label on the left of the image 126.

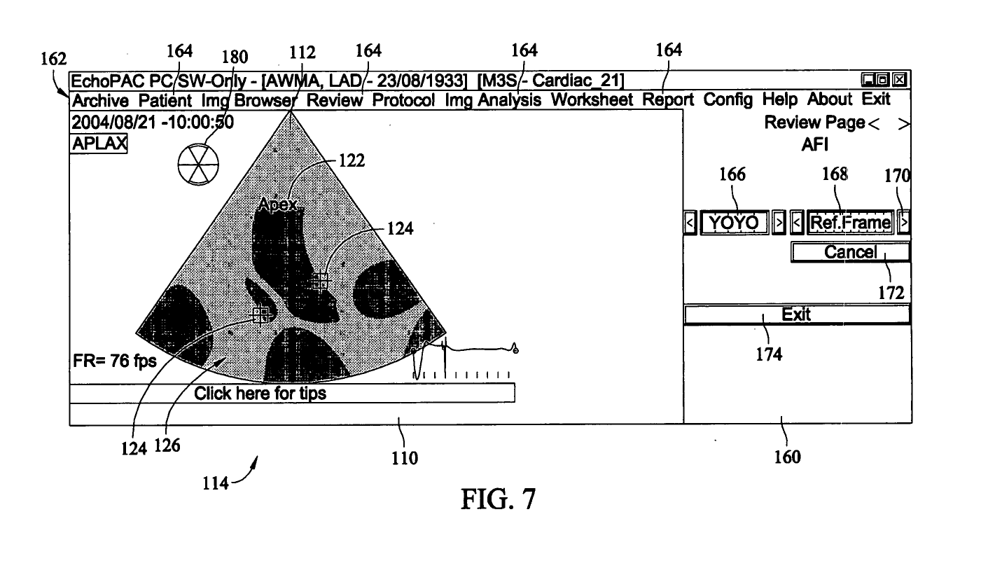

The various embodiments also provide a visualization function that may be used, for example, when identifying and selecting points using the marker 122. In particular, the window 110 may also include a control panel 160 as shown in FIG. 7 that may include different options based on the screen being displayed or the operation being performed. The window 110 also may include a menu portion 162 allowing a user to select different options. For example, different selectable members 164 such as Archive, Patient, Img. Browser, etc. may be selected by a user with a mouse and thereafter provides different options (such as in a drop-down menu) or different functionalities.

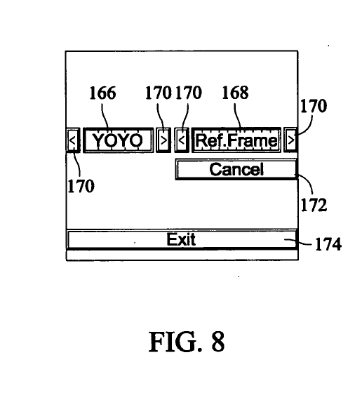

The control panel 160 shown in FIG. 7, a portion of which is shown more clearly in FIG. 8, includes selectable members to initiate a visualization function. In particular, a YOYO selectable member 166 is provided to select the visualization function. For example, when an image 126 in a particular view is being displayed, activation of the YOYO selectable member 166 initiates a visualization function wherein the image memory 40 is accessed and a short loop of image frames before and after the current image frame are displayed, for example, in a cine loop back and forth. A user may select the number of frames for display on both sides of the current (reference) frame using a Ref. Frame selectable member 168. It should be noted that the reference frame may be advanced or reversed and the number of frames before and after the reference frame to include may be increased or decreased using the arrow selectable members 170. A cancel selectable member 172 may be activated to cancel the visualization function and an exit selectable member 174 may be activated to exit the control panel 160. It should be noted that the number of frames selected for viewing in the loop is generally less than a total heart cycle, for example, three frames forward and backward, five frames forward and backward or ten frames forward and backward. However, other numbers of frames are contemplated. Other partial cycles are also contemplated, for example, based on a percentage of the total heart cycle (e.g., images corresponding to thirty percent of the heart cycle), within a predetermined period of a heart activity event (e.g., 250 milliseconds after the beginning of heart contraction), using standard formulas for dividing the heart cycle into systole and diastole frames based on an ECG among others. In one embodiment, the images are displayed back and forth from the first to the last image frames in the selected group of image frames.

The visualization function may be used when marking points on the image 126 to distinguish, for example, the border between the heart muscle being displayed and the cavity full of blood being displayed. The marker 122 may be moved to a point on the image 126 and selected with the image 126 moving during the loop, paused at a point in the loop, or on the static reference image.

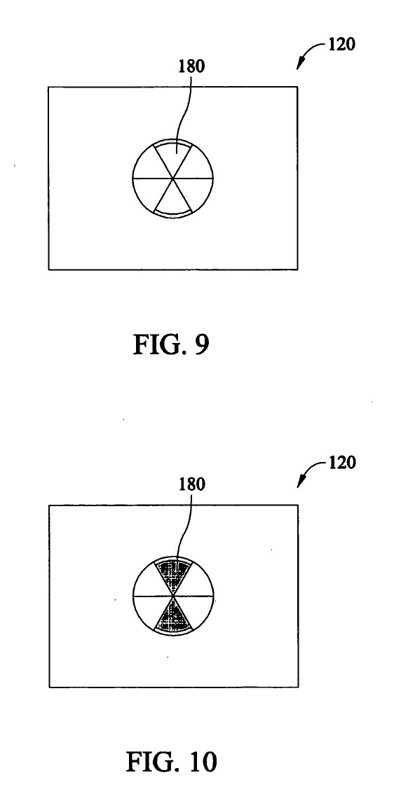

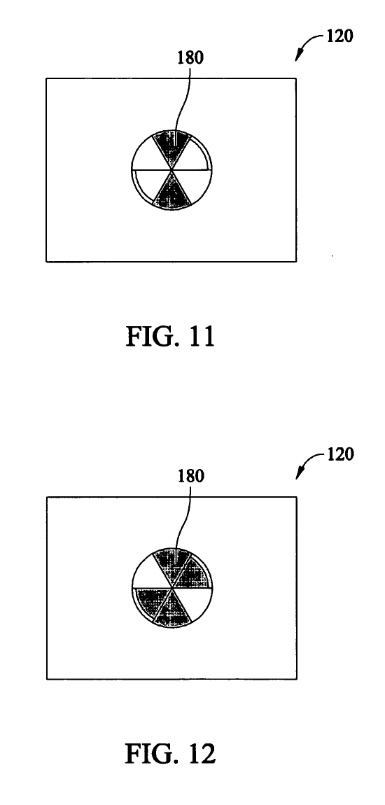

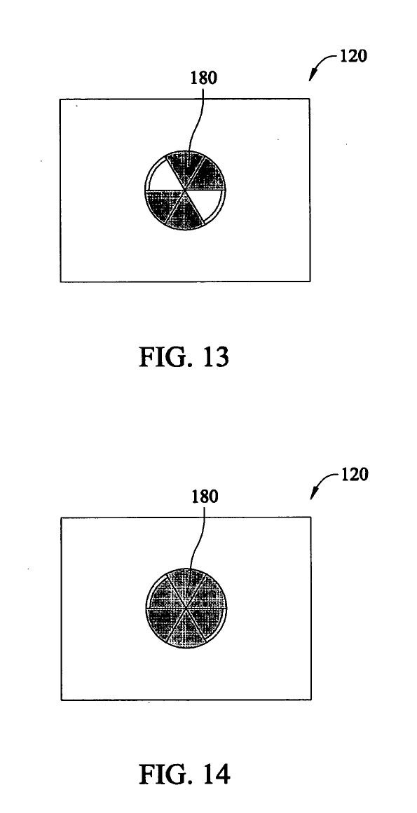

Referring again to FIG. 3, the status indicator 120 is configured as a graphical indication of the status of a current operation of the status of an overall operation. The shading of the segments 180 of the status indicator provides a visual indication of the status of system processing. Referring again to the example of determining the endocardial border by selecting three points in each of three different views, the status indicator 120 is configured such that two opposing segments 180 provide indication of the status of processing one of the image views. For example, FIGS. 9 and 10 illustrate the shading during processing of the apical long axis image view, FIGS. 11 and 12 illustrate the shading during the processing of the two chamber image view and FIGS. 13 and 14 illustrate the shading during the processing of the four chamber view. Specifically, when a current view is to be processed, a portion of the outer edge or border of the segments 180 for that view is highlighted. In particular, when the apical long axis view is the current view to be processed, then the top middle and bottom middle segments 180 include a highlighted outer edge as shown in FIG. 9. When the processing of the apical long axis image view is complete, for example, when all three points have been selected as described herein, the entire top middle and bottom middle segments are shaded as shown in FIG. 10. A similar shading arrangement is provided for each of the other image views as shown in FIGS. 11 through 14.

It should be noted that once one image view has been processed or at the start of processing, the highlighted outer edge or border may provide an indication as to the image view that is to be processed next. Thus, the highlighting of the outer edge or border can indicate the image view to be selected by a user for processing. Further, when all views have been processed, every segment 180 is shaded as shown in FIG. 14 and when any of the segments 180 are not highlighted that is an indication that one or more views need to be processed. Alternatively, the segments 180 may be shaded different colors depending on the current status, for example, shaded yellow for non-acquired or non-processed image views and shaded green for acquired of processed image views. A determination of when an image view has been processed may be based on the completion of different operations. For example, in one embodiment, an image view is processed upon marking the three points, completing the calculation, confirming the tracking, and approving the operation. Thus, the status indicator 120 provides a continuous and dynamic indication of the status of the processing and/or operations being performed or to be performed.

Various embodiments provide indications on a screen for use when processing images acquired by a medical imaging system, for example, an ultrasound imaging system. For example, the indications may guide a user when providing inputs and/or selecting portions of an image, and provide status information. Additionally, a visualization function also may be provided to assist a user in inputting selections, and in particular, selecting points on an image.

While the invention has been described in terms of various specific embodiments, those skilled in the art will recognize that the invention can be practiced with modification within the spirit and scope of the claims.

What is claimed is:

1. A method for automatically displaying information during medical image processing, the method comprising:
determining an image view for a displayed image generated from acquired scan data;
determining text to display in connection with a marker displayed on the displayed image based on the determined image view, the text indicating a region of the displayed image to identify with the marker; and
displaying automatically the determined text in connection with the marker on the displayed image.

2. A method in accordance with claim 1 further comprising receiving a user input indicating a current image view.

3. A method in accordance with claim 1 further comprising automatically determining a current image view based on an acquired image.

4. A method in accordance with claim 1 wherein the determining comprises determining an order for displaying text based on the image view.

5. A method in accordance with claim 1 further comprising receiving an indication of a selected operation to be performed and determining text to display based on the selected operation.

6. A method in accordance with claim 5 wherein the selected operation is an automatic determination of an endocardial border of a heart.

7. A method in accordance with claim 6 wherein the text corresponds to points on the heart to be identified to determine the endocardial border.

8. A method in accordance with claim 1 further comprising automatically changing the displayed text after a region on the displayed image is identified.

9. A method in accordance with claim 1 further comprising associating the text with the marker such that the text moves with the marker.

10. A method in accordance with claim 1 further comprising providing text indicating portions of the image based on the selected regions.

11. A method in accordance with claim 10 further comprising changing the positioning of the text based on the orientation of the image.

12. A method in accordance with claim 11 further comprising determining the orientation of the image based on the identified regions.

13. A method in accordance with claim 1 wherein the displayed image is a static image.

14. A method in accordance with claim 1 wherein the displayed image is a moving image in a cine loop.

15. A method in accordance with claim 14 further comprising determining a number of image frames to display based on a received indication of a reference image frame and a number of additional frames to display in the cine loop.

16. A method in accordance with claim 15 wherein determining a number of image frames to display is based on a selected percentage of a heart cycle.

17. A method for automatically displaying status information during medical image processing, the method comprising:
determining a status of a current processing operation;
determining a status of an overall processing operation; and
providing an indication of the status of the current processing operation and the overall processing operation on a displayed segment status indicator.

18. A method in accordance with claim 17 further comprising shading at least one segment of the status indicator upon determining that a status of the current processing operation is in a completed processing state or a completed acquisition state.

19. A method in accordance with claim 17 further comprising highlighting an edge of at least one segment of the status indicator upon determining that a status of the current operation is in a non-completed processing state or a non-completed acquisition state.

20. A method in accordance with claim 17 wherein two opposing segments of the status indicator correspond to a single processing operation.

21. A method in accordance with claim 20 wherein the single processing operation correspond to processing a single image view of an acquired medical image.

22. A medical image display comprising:
an image portion displaying an image from an acquired medical imaging scan; and
a non-image portion displaying information relating to the displayed image, the non-image portion including a status indicator having a plurality of segments indicating a status of an operation performed in connection with the displayed image.

23. A medical image display in accordance with claim 22 wherein the status indicator comprises a plurality of segments configured to be one of automatically shaded and highlighted based on a processing status.

24. A medical image display in accordance with claim 22 wherein the non-image portion comprises labels identifying portions of the displayed image, the labels automatically inverting when an image view of the displayed image is inverted.

25. A medical image display comprising:
an image portion displaying an image from an acquired medical imaging scan;
a non-image portion displaying information relating to the displayed image; and
a virtual marker and associated text displayed on the image portion, the associated text automatically displayed based on a determined image view of an image displayed in the image portion, the text indicating a region of the displayed image to identify with the marker.

26. A medical image display in accordance with claim 25 wherein an order for displaying the text is based on the determined image view.
